(19) United States
(12) Patent Application Publication
(10) Pub. No.: US 2026/0318600 A1
(43) Pub. Date: Oct. 15, 2026

(54) MELTING VESSEL FOR AN ELECTRIC ARC FURNACE AND ELECTRIC ARC FURNACE

(71) Applicant: Primetals Technologies Austria GmbH, Linz (AT)

(72) Inventors: Michael SAUERBREY, Urloffen (DE); Michael SCHMID, Biberach/ Baden (DE)

(21) Appl. No.: 19/483,036

(22) PCT Filed: May 16, 2024
(86) PCT No.: PCT/EP2024/063623

§ 371 Date: Nov. 10, 2025

(30) Foreign Application Priority Data
May 17, 2023 (EP) 23174043.2

(51) Int. Cl. F27D 1/00; C21C 5/52; F27D 3/15; F27D 27/00

(52) U.S. Cl. CPC F27D 1/0043; C21C 5/5264; F27D 3/1518; F27D 27/00; F27D 2001/0063

(57) ABSTRACT

The invention is in the field of steel manufacture, specifically in the field of steel manufacture using an electric arc furnace. The aim of the present invention is to offer a cost-effective solution and to allow for different expansion behaviors of the materials used. This aim is achieved in that the side wall (3) and a first portion of the melting vessel base, which is connected to the closed side wall (3), are manufactured from a metal, preferably steel having magnetic properties. A second portion of the melting vessel base (4), which is enclosed by the first portion, is designed as a recess (5); the recess (5) is closed by a cover sheet (10) having non-magnetic properties. The cover sheet (10) has an overlapping support face which rests on the first portion; the cover sheet (10) is mounted floatingly. Stops (11) that are arranged accordingly ensure that the cover sheet (5) always has an overlapping support face (4a) across the entire periphery of the recess (5).

### TECHNICAL FIELD

The invention is in the field of steel production, specifically in the field of steel production using an electric arc furnace. The invention relates to a melting vessel, having a closed side wall and a melting vessel bottom having a bottom surface, for an electric arc furnace.

### PRIOR ART

In the production of steel in an electric arc furnace, steel bath movements are typically realized using Intergas porous plugs installed in the melting vessel.

A newer way of mixing the steel bath involves an electromagnetic stirring device installed below the lower vessel. As the lower vessel is typically made of steel, it would prevent the magnetic flux from passing from the stirring coil to the melt. One possible, but very expensive, solution is to manufacture the melting vessel from non-magnetic material. Another possibility is to weld a non-magnetic material in a partial region of the melting vessel. However, such a material is not easy to install, as it usually has a different material expansion behavior in the temperature range that occurs in an electric arc furnace.

CA2740528A1 shows an arrangement for fastening an electromagnetic stirrer to a vessel side wall of a vessel for receiving liquid materials.

CN106170353A discloses a non-magnetic steel structure that enables a magnetic field to be transferred from an electromagnetic stirrer or a brake to the melt and can be arranged, for example, in an electric arc furnace.

### SUMMARY OF THE INVENTION

The object of the present invention is firstly to provide a cost-effective solution and secondly to enable the different expansion behaviors of the materials used.

The object is achieved by means of the side wall and a first partial region, which is connected to the closed side wall, of the melting vessel bottom being manufactured from a metal, preferably steel with magnetic properties. A second partial region, which is enclosed by the first partial region, of the melting vessel bottom is configured as a cutout. The cutout is dependent on the size of an electromagnetic stirring device. The size of the electromagnetic stirring device is dependent on the size of the melting vessel and the stirring effect to be achieved on the melt. The cutout is closed by a cover plate, which has non-magnetic properties, wherein the cover plate has an overlapping bearing surface, which bears against the first partial region. The cover plate is floatingly mounted and correspondingly arranged stops ensure that the cover plate always has an overlapping bearing surface over an entire circumference of the cutout.

The cover plate normally has a different expansion behavior than the metal from which the rest of the melting vessel bottom is manufactured. Therefore, it must be ensured that the cover plate is able to expand independently of the rest of the melting vessel bottom without additional stresses on account of the expansion behavior of the cover plate being introduced into the melting vessel bottom.

The stops must be used to ensure that the cover plate does not slide in such a manner that there is no longer any overlapping bearing surface. The stops can be welded-on plates that, upon reaching a side surface of the cutout, prevent further displacement in this direction. However, it is also conceivable for the cover plate to be limited by the side wall in such a manner that, when it slides, the cover plate always has an overlapping bearing surface. The size of the cutout depends on the size of an electromagnetic stirring device to be used.

The cutout has a projected surface area of at least 10% of a projected bottom surface area. In most cases, the melting vessel bottom is not a straight surface, and therefore use is made of the projected surface area. The size depends on the dimensions of the electromagnetic stirring device and the way in which magnetic flux generated by the electromagnetic stirring device propagates.

In a preferred design, the cutout has at least the size that corresponds to at least that projected surface area or substantially that projected surface area that has a cutout-proximal surface of an electromagnetic actuator, preferably an electromagnetic stirring device, which can be arranged therebelow.

In an expedient design, the first partial region has at least a width of at least 500 mm over the entire circumference.

In a particularly preferred variant, the stops are the side wall of the melting vessel, welded-on stops on the cover plate, a step in the melting vessel bottom and/or welded-on stops on the vessel bottom.

In an expedient design, the cover plate made of one of the following materials consists of austenitic stainless steel, such as a steel with the material number 1.4828, for example.

In an advantageous design, in the region of a tapping opening, in a maximally displaceable position, the cover plate has no overlap with the tapping opening, preferably has at least a spacing of 50 mm, particularly preferably has a spacing of 100 mm.

The exact design of the tapping opening is dependent on the shape of the cutout. It is also conceivable for the cover plate to have a slot or a cutout in the shape of a circular segment.

In a preferred embodiment, the cover plate has, on an underside, stiffening plates, which protrude through the cutout.

It is conceivable for at least 3 stops, which also simultaneously serve as stiffening plates, to be arranged.

In another preferred embodiment, the cover plate is arcuate, in the shape of a spherical segment or bent. These designs increase static strength, as a result of which larger loads can be absorbed than in the case of a planar bottom.

The arcuate design is the configuration in which the cover plate has the shape of a circular arc, for example. The exact shape of the arc depends on the shape of the melting vessel bottom. The bent design has at least one bent edge and is bent in such a manner that the shape is adapted to that of the melting vessel bottom.

In another advantageous design, the melting vessel has a refractory lining on the cover plate and the first partial region of the melting vessel bottom, and the side wall also has a refractory lining. As it expands, the cover plate presses into the lining and can expand in this way.

In an expedient embodiment, the first partial region of the melting vessel bottom is manufactured in one piece or by means of non-releasable connections. The first partial region either consists of one piece or is made by means of non-releasable connections, for example by welding connections. However, it is of course conceivable for add-on parts, which are not required for the function of a melting vessel bottom, to be fastened to the first partial region of the melting vessel bottom by means of releasable connections.

In an advantageous embodiment, the cover plate is manufactured in one piece or by means of non-releasable connections. The cover plate either consists of one piece or is made by means of non-releasable connections, for example by welding connections. However, it is of course conceivable for add-on parts, which are not required for the function of a cover plate, to be fastened to the cover plate by means of releasable connections.

In a preferred embodiment, the cutout has a projected surface area of at least 20%, preferably at least 30%, particularly preferably at least 40%, most preferably at least 50%, of a projected bottom surface area.

In an advantageous embodiment, the cover plate is manufactured from a non-magnetic metal, preferably non-magnetic steel.

The object is also achieved by an electric arc furnace comprising a previously described melting vessel and an electromagnetic stirring device arranged on the underside in the second partial region of the melting vessel.

### BRIEF DESCRIPTION OF THE DRAWINGS

The above-described properties, features and advantages of this invention, and the manner in which these are achieved, will become clearer and more clearly comprehensible in conjunction with the following description of one exemplary embodiment, which will be explained in more detail in conjunction with the drawings, in which:

FIGS. 1 to 4 show schematic depictions of various embodiments of a melting vessel

FIGS. 5 to 8 show schematic depictions of an electric arc furnace with one embodiment of an inventive melting vessel.

### DESCRIPTION OF THE EMBODIMENTS

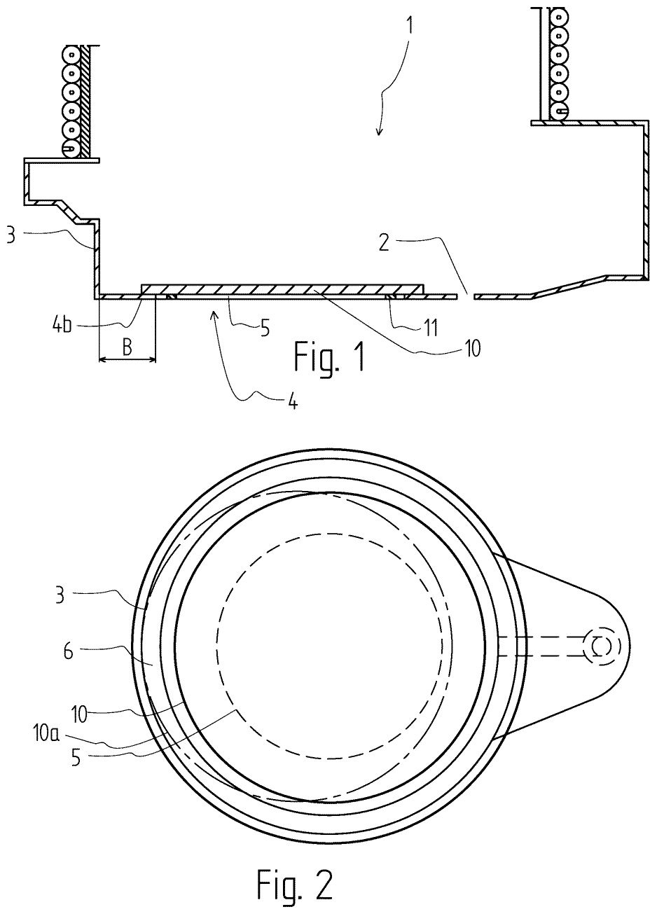

FIG. 1 depicts an embodiment of a melting vessel 1 according to the invention. The melting vessel 1 consists of a closed side wall 3 and a melting vessel bottom 4, wherein the melting vessel bottom 4 consists of a first partial region 4b and a second partial region, wherein the second partial region is a cutout 5. The cutout 5 is closed by a cover plate 10. This cover plate 10 has non-magnetic properties, so that an electromagnetic stirring device placed therebelow can operate as efficiently as possible and the stirring effect can reach the melt with minimal hindrance. The cover plate 10 has stops 11, which the cover plate 10 slides, that it always has a bearing surface on the melting vessel bottom 4 on the entire circumference. In addition, the stops 11 should also ensure that the cover plate 10 does not overlap with a tapping opening 2. The stops 11 can also be configured as a stiffening plate so that the cover plate 10 meets the necessary mechanical requirements. FIG. 1 depicts a width B of the melting vessel bottom 4, this width B being at least 500 mm in order to have a sufficient bearing surface available for the cover plate 10.

FIG. 2 depicts a plan view of an embodiment of a melting vessel 1 according to the invention. The melting vessel 1 also has a cutout 5, which is closed using a cover plate 10. The melting vessel 1 has a closed side wall 3, which has a lining 6. In a displaced position of the cover plate 10a, the side wall 3 serves as a stop, thus ensuring that an overlap of the cutout 5 with the cover plate 10 is always ensured.

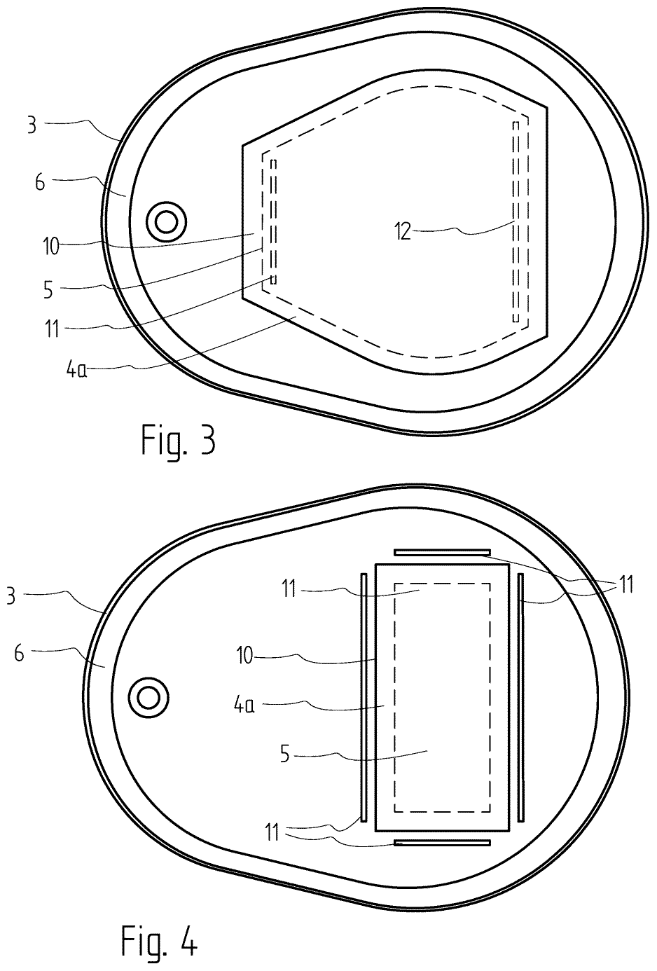

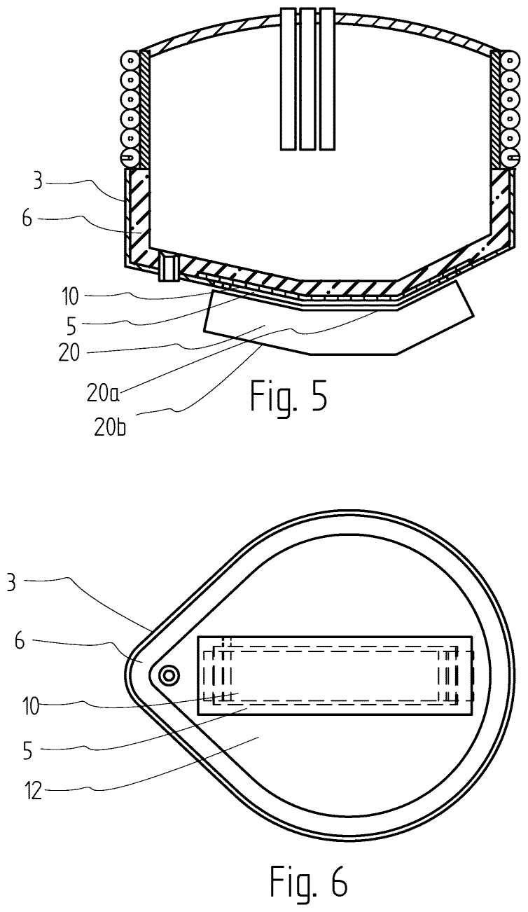

FIG. 3 and FIG. 4 depict further embodiments of a melting vessel 1 according to the invention. The cover plate 10 has corresponding stops 11, which ensure that, when the cover plate 10 slides, there is always an overlap between the cutout 5 and the cover plate 10. The overlapping bearing surface 4a can be seen very clearly in FIG. 3 and FIG. 5. In FIG. 4, the stops 11 are attached to the melting vessel bottom 4.

FIG. 5 and FIG. 6 schematically depict an embodiment of an electric arc furnace having a melting vessel 1 and an electromagnetic stirring device 20. The electromagnetic stirring device 20 is arranged directly below the cover plate 10, which covers the cutout 5. FIG. 5 also depicts the lining 6, which is present both on the melting vessel bottom 4 and on the side wall 3. The cutout 5 has at least a size that corresponds to the projected surface area of the proximal side 20a of the electromagnetic stirring device 20. A projected surface area of the distal side 20b of the electromagnetic stirring device 20 may, depending on the embodiment, be larger than the projected surface area of the cutout 5.

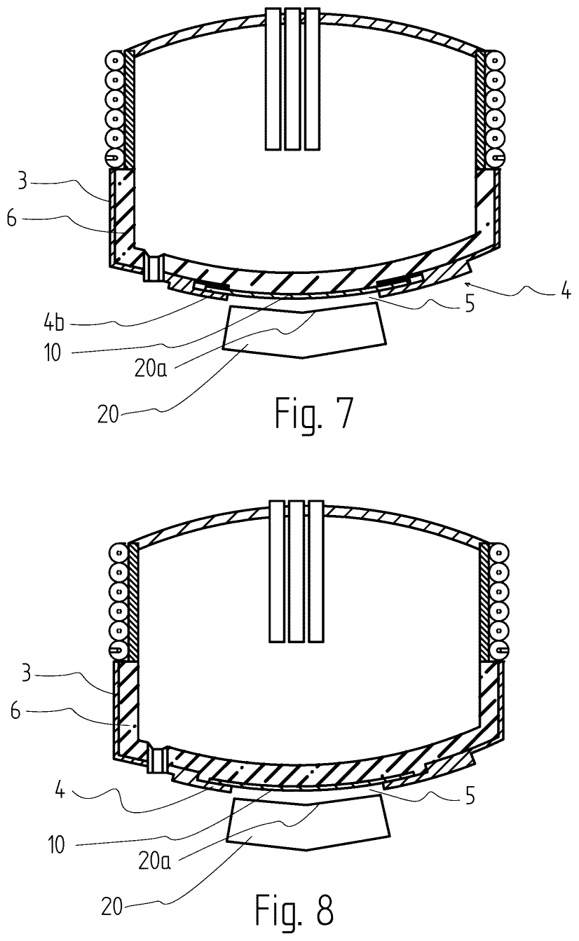

FIG. 7 and FIG. 8 each show an embodiment of an electric arc furnace having a melting vessel bottom 4, which has a step shape in the first partial region 4b. The cover plate 10 is inserted into this step shape. This step shape can also simultaneously serve as a stop. Moreover, the cover plate 10 is arcuate or in the shape of a spherical segment.

Although the invention has been more specifically illustrated and described in detail by the preferred exemplary embodiments, the invention is not limited by the examples disclosed and other variations may be derived therefrom by a person skilled in the art without departing from the scope of protection of the invention.

### LIST OF REFERENCE SIGNS

1 Melting vessel
2 Tapping opening
3 Side wall
4 Melting vessel bottom
4a Bearing surface
4b First partial region
5 Cutout
6 Lining
10, 10a Cover plate
11 Stops
20 Electromagnetic stirring device
20a Proximal side
20b Distal side
B Width

1. A melting vessel, having a closed side wall and a melting vessel bottom having a bottom surface, for an electric arc furnace, characterized in that the side wall and a first partial region, which is connected to the closed side wall, of the melting vessel bottom are manufactured from a metal, preferably steel with magnetic properties, and a second partial region, which is enclosed by the first partial region, of the melting vessel bottom is configured as a cutout, the cutout is closed by a cover plate, which has non-magnetic properties, wherein the cover plate has an overlapping bearing surface, which bears against the first partial region, the cover plate is floatingly mounted and correspondingly arranged stops ensure that the cover plate always has an overlapping bearing surface over an entire circumference of the cutout, wherein the cutout has a projected surface area of at least 10% of a projected bottom surface area.

2. The melting vessel as claimed in claim 1, wherein the cutout has at least the size that corresponds to at least that projected surface area or substantially that projected surface area that has a cutout-proximal surface of an electromagnetic actuator, preferably an electromagnetic stirring device, which can be arranged therebelow.

3. The melting vessel as claimed in claim 1, wherein the first partial region has at least a width [[(B) of at least 500 mm over the entire circumference.

4. The melting vessel as claimed in claim 1, wherein the stops are the side wall of the melting vessel, welded-on stops on the cover plate, a step in the melting vessel bottom and/or welded-on stops on the melting vessel bottom.

5. The melting vessel as claimed in claim 1, wherein the cover plate is manufactured from austenitic stainless steel.

6. The melting vessel as claimed in claim 1, wherein in the region of a tapping opening, has no overlap with the tapping opening, preferably has at least a spacing of 50 mm from the tapping opening, particularly preferably a spacing of 100 mm.

7. The melting vessel as claimed in claim 1, wherein the cover plate has, on its underside, stiffening plates, which protrude through the cutout.

8. The melting vessel as claimed in claim 1, wherein the cover plate is arcuate, in the shape of a spherical segment or bent.

9. The melting vessel as claimed in claim 1, wherein the melting vessel has a refractory lining on the cover plate and the first partial region of the melting vessel bottom, and the side wall also has a refractory lining.

10. The melting vessel as claimed in claim 1, wherein the first partial region of the melting vessel bottom is manufactured in one piece or by means of non-releasable connections.

11. The melting vessel as claimed in claim 1, wherein the cover plate is manufactured in one piece or by means of non-releasable connections.

12. The melting vessel as claimed in claim 1, wherein the cutout has a projected surface area of at least 20%, preferably at least 30%, particularly preferably at least 40%, most preferably at least 50%, of a projected bottom surface area.

13. The melting vessel as claimed in claim 1, wherein the cover plate is manufactured from a non-magnetic metal, preferably non-magnetic steel.

14. An electric arc furnace comprising a melting vessel as claimed in claim 1 and an electromagnetic stirring device arranged on the underside in the second partial region of the melting vessel.
